(19) United States
(12) Patent Application Publication
(10) Pub. No.: US 2007/0002726 A1
(43) Pub. Date: Jan. 4, 2007

(54) System and method for adapting a cyclic prefix in an orthogonal frequency division multiplexing (OFDM) system

(76) Inventor: Kambiz C. Zangi, Chapel Hill, NC (US)

Correspondence Address: ERICSSON INC., 6300 LEGACY DRIVE, M/S EVR C11, PLANO, TX, 75024, US

(21) Appl. No.: 11/173,137

(22) Filed: Jul. 1, 2005

(51) Int. Cl. H04J 11/00

(52) U.S. Cl. 370/208

(57) ABSTRACT

A system and method for adapting a cyclic prefix (CP) length to a delay spread in a cell in an OFDM cellular communication network. The system determines the longest delay spread in any cell in the network and determines the delay spread for the cell. The CP length for the cell is set to a value equal to or longer than the longest delay spread if the cell's delay spread is equal to the longest delay spread. However, if the cell's delay spread is shorter than the longest delay spread, the CP length for the cell is set to a value equal to or longer than the cell's delay spread and shorter than the longest delay spread. A broadcasting unit broadcasts the value of the cell's CP length over a downlink synchronization channel (DSCH) utilizing a CP length equal to or longer than the longest delay spread to ensure all user terminals can receive the broadcast.

### BACKGROUND

The present invention relates to cellular communication systems. More particularly, and not by way of limitation, the present invention is directed to a system and method for adapting the length of a cyclic prefix to an expected delay spread in an Orthogonal Frequency Division Multiplexing (OFDM) cellular communication system.

OFDM modulation is increasingly being considered for the physical layer of fourth generation (4G) cellular communication systems. Typically, each OFDM symbol consists of two parts: (1) a useful part, and (2) a cyclic prefix (CP). The CP is a duplicate of the last “M” samples of the useful part. The CP does not carry any data, but is necessary to ensure that OFDM sub-carriers do not interfere with each other. The longer the CP becomes, the less data the OFDM symbol can carry in the useful part. Therefore, it is highly desirable to keep the length of the CP as short as possible. However, the length of the CP must be at least as long as the delay spread of the channel.

In cellular communication systems, the geographic service area is divided into a number of cells. Each cell includes an access point (AP), which transmits information to user terminals (UTs) operating within the cell, and receives information from the UTs. In each cell, OFDM modulation may be utilized on the downlink between the AP and a UT or on the uplink between the UT and the AP. The delay spread in each cell varies based on the geometry of the cell such as the number of reflectors, the distance between the reflectors, the absorption coefficient of each reflector, and the like.

To ensure that the length of the CP is longer than the delay spread in each cell, it has been known to use a CP of the same length in every cell. When this is done, however, the length of the CP must be chosen to be longer than the longest delay spread in any of the cells. In other words, the CP length is chosen for the worst-case delay spread over all the cells. Since the delay spread varies from cell to cell, there are many cells in which the CP length is considerably longer than the delay spread. Thus, there is unnecessary overhead in many cells, reducing the amount of useful data that can be transmitted in the cellular system.

Another known approach of ensuring that the length of the CP is longer than the delay spread in each cell is for each AP to determine the delay spread in its own cell, and to set the length of the CP in its cell to a length that is longer than the determined delay spread. This results in a different CP length in each cell. The problem with this approach is that a UT entering a given cell does not know what CP length is being utilized in that cell. The UT must enter blindly, and perform a lengthy procedure to determine the CP length before a connection can be established. This causes additional delay before the UT and the AP can start communicating useful data (e.g., delay before the UT and AP can start a voice call).

What is needed in the art is a system and method for adapting the length of the cyclic prefix to an expected delay spread in an OFDM cellular communication system that overcomes the disadvantages of the existing art. The present invention provides such a system and method.

### SUMMARY

The present invention provides a system and method for adapting the length of the cyclic prefix to an expected delay spread in an OFDM cellular communication system. In addition, the invention adapts the CP on a per-cell basis, and broadcasts the actual length of the CP to be utilized in each cell to UTs operating in the cell.

Thus, in one aspect, the present invention is directed to a method of adapting a length of a cyclic prefix to a delay spread in an OFDM cellular communication system. The method includes determining a longest delay spread that is the longest delay spread in any cell in the cellular communication system; determining a given delay spread in a given cell; and, if the given delay spread is equal to the longest delay spread, setting the length of the cyclic prefix in the given cell to a value equal to or longer than the longest delay spread. However, if the given delay spread is shorter than the longest delay spread, the method sets the length of the cyclic prefix in the given cell to a value that is equal to or longer than the given delay spread and shorter than the longest delay spread. The method may also include broadcasting the value of the length of the cyclic prefix in the given cell utilizing a cyclic prefix with a length equal to or longer than the longest delay spread.

In another aspect, the present invention is directed to a method of adapting a length of a cyclic prefix to a delay spread in an OFDM cellular communication system that includes the steps of determining the delay spread in every cell in the cellular communication system; determining the longest delay spread in any cell in the cellular communication system; and defining a short cyclic prefix length that is shorter than the longest delay spread. The method also includes determining for a given cell, whether the cell's delay spread is shorter than the short cyclic prefix length. If the cell's delay spread is longer than the short cyclic prefix length, the cell's cyclic prefix length is set to a value equal to or longer than the longest delay spread. However, if the cell's delay spread is shorter than the short cyclic prefix length, the cell's cyclic prefix length is set to a value equal to the short cyclic prefix length. The method may also include broadcasting the value of the of the cyclic prefix length in the cell utilizing a cyclic prefix with a length equal to or longer than the longest delay spread.

In yet another aspect, the present invention is directed to a system for adapting a cyclic prefix length to a delay spread in an access point in a given cell in an OFDM cellular communication network. The system includes a delay spread measurement unit for determining a given delay spread in the given cell; communication means for receiving from the network, a value of the longest delay spread in any cell in the network; and a cyclic prefix length determination unit adapted to receive the given delay spread and the value of the longest delay spread, and to determine a cyclic prefix length for the given cell. The determination unit is adapted to set the cyclic prefix length in the given cell to a value equal to or longer than the longest delay spread if the given delay spread is equal to the longest delay spread. However, if the given delay spread is shorter than the longest delay spread, the determination unit sets the cyclic prefix length in the given cell to a value equal to or longer than the given delay spread and shorter than the longest delay spread. The system may also include a broadcasting unit for broadcasting the value of the length of the cyclic prefix in the given cell utilizing a cyclic prefix with a length equal to or longer than the longest delay spread.

### BRIEF DESCRIPTION OF THE SEVERAL VIEWS OF THE DRAWINGS

In the following, the essential features of the invention will be described in detail by showing preferred embodiments, with reference to the figures of the attached drawings.

FIG. 1 is a flow chart illustrating the steps of a first embodiment of the present invention;

FIG. 2 is a flow chart illustrating the steps of a second embodiment of the present invention;

FIG. 3 illustrates an OFDM symbol for a downlink channel in a cell having a long delay spread;

FIG. 4 illustrates an OFDM symbol for a downlink channel in a cell having a short delay spread and a shortened cyclic prefix adapted in accordance with the present invention; and

FIG. 5 is a simplified block diagram of the system of the present invention.

### DETAILED DESCRIPTION

The present invention provides a method of adapting the length of the cyclic prefix to an expected delay spread in an OFDM cellular communication system. In addition, the invention adapts the CP on a per-cell basis, and broadcasts the actual length of the CP to be utilized in each cell to UTs operating in the cell.

In a cellular system, the AP in each cell typically transmits access information on a downlink synchronization channel (DSCH). The access information may include information such as the identity of the AP, synchronization timing information, frequency corrections, and the like. Each UT reads the access information from the DSCH before the UT attempts to communicate with the AP.

In the present invention, the AP in each cell transmits on the DSCH, the length of the CP being utilized in that cell. Since the delay spread is a function of the geometry of each cell, and the geometry of each cell is generally fixed, each AP can select an appropriate CP length that is slightly longer than or equal to the delay spread in the AP's cell. To ensure that all UTs can read the information on the DSCH, the length of the CP utilized for the DSCH broadcast is set to a fixed length equal to the longest delay spread in any cell. Thus, a worst-case CP length is utilized to inform the UTs of the shorter CP lengths being utilized in each cell.

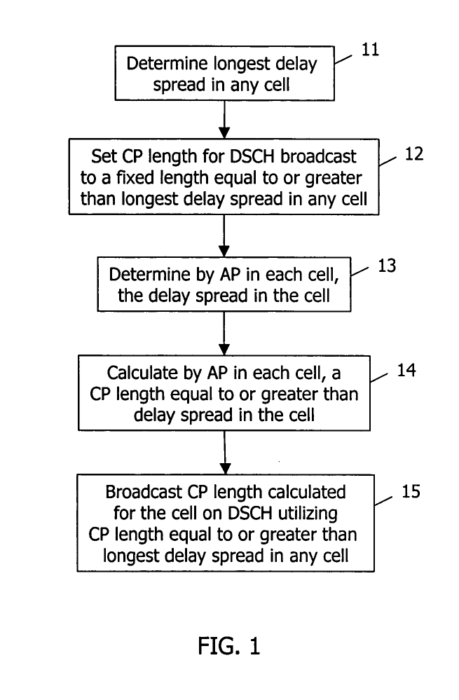

FIG. 1 is a flow chart illustrating the steps of a first embodiment of the present invention. At step 11, the longest delay spread in any cell in the network is determined. At step 12, the length of the CP utilized for the DSCH broadcast is set to a fixed length equal to the longest delay spread in any cell. At step 13, each AP determines the delay spread for the AP's cell. At step 14, each AP then selects an appropriate CP length that is slightly longer than or equal to the delay spread in the AP's cell. At step 15, the AP in each cell transmits on the DSCH, the length of the CP being utilized in that cell. To ensure that all UTs can read the information on the DSCH, the length of the CP utilized for the DSCH broadcast is set to a fixed length equal to the longest delay spread in any cell.

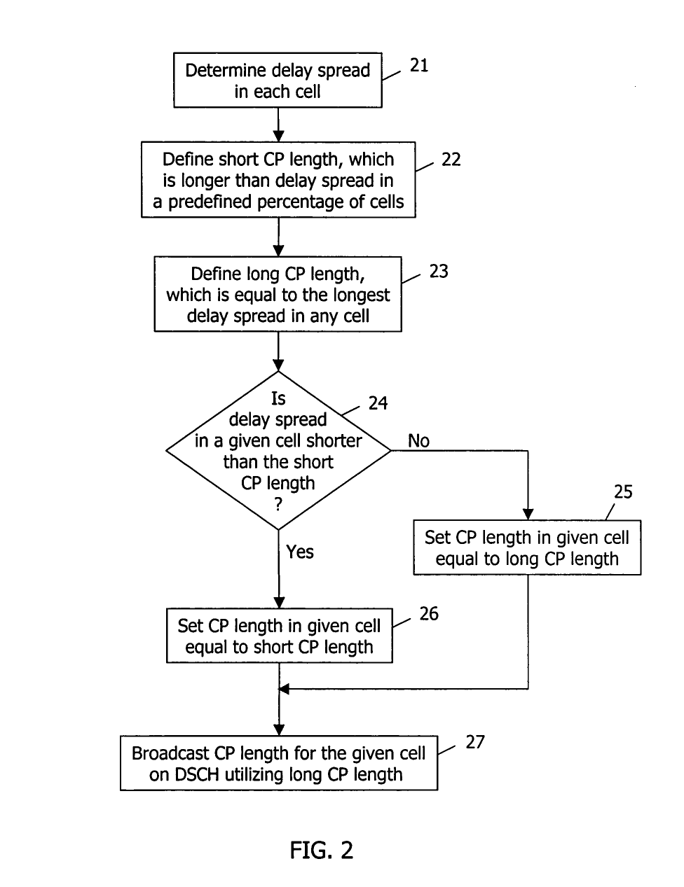

FIG. 2 is a flow chart illustrating the steps of a second embodiment of the present invention. This embodiment utilizes a long CP length for cells with long delay spreads, and utilizes a short CP length for cells with short delay spreads. At step 21, the longest delay spread in any cell in the network is determined. At step 22, the short CP length is defined. The short CP length may be defined so that a predefined percentage of cells in the network, which have delay spreads shorter than the short CP length, can utilize the short CP length for OFDM symbols. For example, if it is desired that 50 percent of the cells in the network utilize the short CP length, and 50 percent of the cells in the network have delay spreads shorter than 500 samples, the short CP length may be set at 500 samples.

At step 23, the long CP length is defined. The long CP length is equal to or longer than the longest delay spread in any cell. For example, if the longest delay spread in any cell is 1012 samples, the long CP length may be set at 1012 samples. At step 24, it is determined whether the delay spread in a given cell is shorter than the short CP length. If not, the process moves to step 25 where the CP length in the given cell is set equal to the long CP length. However, if the delay spread in the given cell is shorter than the short CP length, the process moves to step 26 where the CP length in the given cell is set equal to the short CP length. At step 27, the AP for the given cell broadcasts the selected CP length on the DSCH utilizing the long CP length for the broadcast.

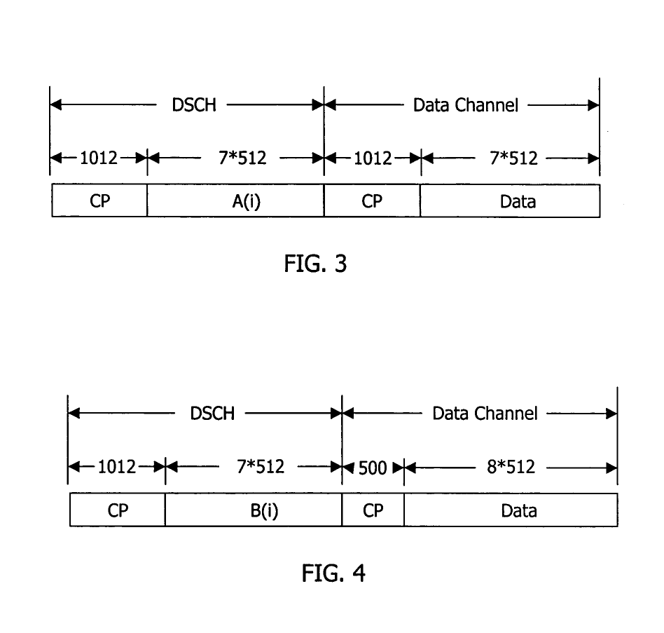

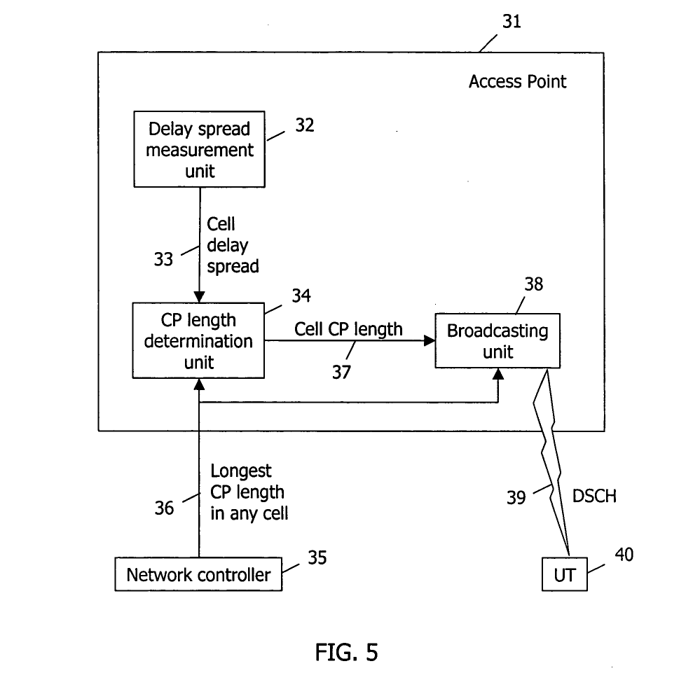

FIGS. 3 and 4 illustrate OFDM symbols for a downlink channel in a cell, which have been adapted in accordance with the embodiment of FIG. 2. It is assumed in both figures that each OFDM symbol consists of Q=4596 samples, and the longest delay spread in any of the cells is shorter than or equal to 1012 samples. Thus, the CP length for the DSCH is set at 1012 samples in both figures. In the example shown in FIG. 3, the cell has a delay spread longer than the short CP length (i.e., longer than 500 samples). Therefore, the long CP length (i.e., 1012 samples) is utilized for the CP on the data channel.

In the example shown in FIG. 4, the cell has a delay spread shorter than the short CP length (i.e., shorter than 500 samples). Therefore, the short CP length (i.e., 500 samples) is utilized for the CP on the data channel. As a consequence, additional useful data can be carried. As noted above, the DSCH always uses a CP length equal to or longer than the longest delay spread in any cell (i.e., 1012 samples).

In those cells where the delay spread is expected to be longer than 500 samples, the useful part of the DSCH is a sequence, A(i), of length 7*512, from the set of sequences {(j): j=1, . . . , J}. Likewise, the useful part of the data channel is of length 7*512. In cells where the delay spread is expected to be shorter than 500 samples, the useful part of the DSCH is a sequence, B(i), also of length 7*512, from the set of sequences {B(j): j=1, . . . , J}. In these cells, the useful part of the data channel is of length 8*512.

As noted above, in FIGS. 3 and 4, the total number of samples in each OFDM symbol is fixed at Q=4596 samples, regardless of the length of the CP. If Ml is used to designate 1012 samples, and M2 is used to designate 500 samples, the length of the useful part of each OFDM symbol is Q-M1 or Q-M2 samples. To demodulate the OFDM symbol, a receiver typically takes a Discreet Fourier Transform (DFT) of size equal to the length of the useful part of the OFDM symbol. It is desirable to make the length of the DFT such that the DFT can be computed efficiently. In the exemplary case shown, it is desirable to ensure that a (Q-M1)-point DFT and a (Q-M2)-point DFT can be computed efficiently. Typically, a DFT length that can be expressed as a product of small prime numbers can be computed efficiently using mixed-radix techniques. In FIG. 1, the length of the DFTs in the data channel is 7*512; therefore, these DFTs can be computed efficiently using radix-2 and radix-7 Fast Fourier Transforms (FFTs). In FIG. 2, the length of the DFTs in the data channel is 8*512=4096; therefore, these DFTs can be computed efficiently using radix-2 FFTs.

For simplicity of illustration, the embodiment shown FIGS. 2-4 utilizes only two optional CP lengths. It should be understood, however, that finer granularity may be achieved by defining additional CP lengths for use by the APs in their respective cells. For example, CP lengths may be defined at every 100 samples so that, for example, a CP length of 600 may be utilized in a cell having a delay spread greater than 500 and less than 600 samples. Alternatively, as described in the first embodiment, each AP may set the CP length in its cell to any length equal to or longer than the cell's measured delay spread.

FIG. 5 is a simplified block diagram of the system of the present invention. In one embodiment, the system is implemented in an access point (AP) 31 in a given cell in an OFDM cellular communication network. The system may also be implemented in a network control node that determines the cyclic prefix length for each cell and informs the AP in each cell what cyclic prefix length to utilize. A delay spread measurement unit 32 determines the cell delay spread 33 in the AP's cell. The cell delay spread is sent to a CP length determination unit 34. The CP length determination unit also receives from a network control node 35, a value of the longest delay spread 36 in any cell in the network. The CP length determination unit determines a cell CP length 37 for the AP's cell and provides the cell CP length to a broadcasting unit 38. The broadcasting unit broadcasts the cell CP length over the DSCH 39 to a UT 40. The DSCH utilizes a CP with a length equal to or longer than the longest delay spread to ensure all UTs can receive the broadcast.

The CP length determination unit 34 sets the cell CP length 37 to a value equal to or longer than the longest delay spread 36 if the cell delay spread 33 is equal to the longest delay spread. However, if the cell delay spread 33 is shorter than the longest delay spread 36, the determination unit sets the cell CP length to a value equal to or longer than the given delay spread and shorter than the longest delay spread.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of adapting a length of a cyclic prefix to a delay spread in an Orthogonal Frequency Division Multiplexing (OFDM) cellular communication system, said method comprising:
determining a longest delay spread that is the longest delay spread in any cell in the cellular communication system;
determining a given delay spread in a given cell;
if the given delay spread is equal to the longest delay spread, setting the length of the cyclic prefix in the given cell to a value equal to or longer than the longest delay spread; and
if the given delay spread is shorter than the longest delay spread, setting the length of the cyclic prefix in the given cell to a value equal to or longer than the given delay spread and shorter than the longest delay spread.

2. The method as claimed in claim 1, further comprising broadcasting from an access point in the given cell, the value of the length of the cyclic prefix in the given cell.

3. The method as claimed in claim 2, wherein the broadcasting step includes broadcasting the value of the length of the cyclic prefix utilizing a synchronization channel and utilizing a cyclic prefix with a length equal to or longer than the longest delay spread.

4. A method of adapting a length of a cyclic prefix to a delay spread in an Orthogonal Frequency Division Multiplexing (OFDM) cellular communication system, said method comprising:
determining the delay spread in every cell in the cellular communication system;
determining the longest delay spread in any cell in the cellular communication system;
defining a short cyclic prefix length that is shorter than the longest delay spread;
for a given cell, determining whether the cell's delay spread is shorter than the short cyclic prefix length;
if the cell's delay spread is longer than the short cyclic prefix length, setting the cell's cyclic prefix length to a value equal to or longer than the longest delay spread; and
if the cell's delay spread is shorter than the short cyclic prefix length, setting the cell's cyclic prefix length to a value equal to the short cyclic prefix length.

5. The method as claimed in claim 4, further comprising broadcasting from an access point in the cell, the value of the cyclic prefix length in the cell.

6. The method as claimed in claim 5, wherein the broadcasting step includes broadcasting the value of the cyclic prefix length utilizing a synchronization channel and utilizing a cyclic prefix with a length equal to or longer than the longest delay spread.

7. The method as claimed in claim 4, wherein the step of defining a short cyclic prefix length includes defining a plurality of short cyclic prefix lengths that are shorter than the longest delay spread.

8. The method as claimed in claim 7, wherein the step of setting the cell's cyclic prefix length to a value equal to the short cyclic prefix length includes setting the cell's cyclic prefix length equal to the first of the defined plurality of cyclic prefix lengths that is greater than the cell's delay spread.

9. A system for adapting a cyclic prefix length to a delay spread in a given cell in an Orthogonal Frequency Division Multiplexing (OFDM) cellular communication network, said system comprising:
a delay spread measurement unit for determining a given delay spread in the given cell;
communication means for receiving from the network, a value of the longest delay spread in any cell in the network;
a cyclic prefix length determination unit adapted to receive the given delay spread and the value of the longest delay spread, and to determine a cyclic prefix length for the given cell, wherein the determination unit is adapted to:
set the cyclic prefix length in the given cell to a value equal to or longer than the longest delay spread if the given delay spread is equal to the longest delay spread; and
set the cyclic prefix length in the given cell to a value equal to or longer than the given delay spread and shorter than the longest delay spread if the given delay spread is shorter than the longest delay spread.

10. The system as claimed in claim 9, wherein the system is implemented in a network control node.

11. The system as claimed in claim 9, wherein the system is implemented in an access point in the given cell.

12. The system as claimed in claim 11, further comprising a broadcasting unit in the access point for broadcasting in the given cell, the value of the cyclic prefix length in the given cell.

13. The system as claimed in claim 12, wherein the broadcasting unit broadcasts the value of the length of the cyclic prefix utilizing a synchronization channel and utilizing a cyclic prefix with a length equal to or longer than the longest delay spread.
